(19) United States
(12) Patent Application Publication
(10) Pub. No.: US 2026/0321225 A1
(43) Pub. Date: Oct. 15, 2026

(54) DISPLAY CONTROL METHOD, DISPLAY CONTROL DEVICE, AND DISPLAY CONTROL SYSTEM

(71) Applicant: Nissan Motor Co., Ltd., Kanagawa (JP)

(72) Inventor: Wataru Yoshida, Kanagawa (JP)

(73) Assignee: Nissan Motor Co., Ltd., Kanagawa (JP)

(21) Appl. No.: 19/485,584

(22) PCT Filed: May 23, 2023
(86) PCT No.: PCT/JP2023/019165

§ 371 Date: Nov. 18, 2025

(51) Int. Cl. G09G 5/12

(52) U.S. Cl. CPC G09G 5/12; G09G 2354/00; G09G 2370/042

(57) ABSTRACT

A first control device transmits an instruction about the display of an image to a second control device in accordance with a time point, controls a first display device such that the first display device displays an image in accordance with the time point, and when the second control device receives the instruction from the first control device, the second control device controls a second display device on the basis of the instruction such that the second display device displays the image.

### TECHNICAL FIELD

The present invention relates to a display control method, a display control device, and a display control system.

### BACKGROUND ART

There is known a technique for a system including a plurality of display devices and a terminal device that gives an instruction to start the display of an image to the plurality of display devices, in which the display devices receiving the instruction to start the display from the terminal device project the image onto their projecting regions (Patent Document 1).

### PRIOR ART DOCUMENT

### Patent Document

Patent Document 1: JP 2019-174772 A

### SUMMARY OF INVENTION

### Problems to be Solved by Invention

However, a problem with the technique according to Patent Document 1 is that it is not possible to control image display on a plurality of display devices with synchronized timings of displaying images in the case where a plurality of terminal devices control the respective display devices.

A problem to be solved by the present invention is to provide a display control method, a display control device, and a display control system that are capable of controlling image display on the plurality of display devices with synchronized timings of displaying images in the case where the plurality of terminal devices control the respective display devices.

### Means for Solving Problems

The present invention solves the above problem as follows. A first control device transmits an instruction about the display of an image to a second control device in accordance with a time point, controls a first display device such that the first display device displays an image in accordance with the time point, and when the second control device receives the instruction from the first control device, the second control device controls a second display device on the basis of the instruction such that the second display device displays the image.

### Effects of Invention

According to the present invention, it is possible to control image display on the plurality of display devices with synchronized timings of displaying images in the case where the plurality of terminal devices control the respective display devices.

### BRIEF DESCRIPTION OF DRAWINGS

FIG. 1 is a block diagram illustrating a configuration of a display control system according to the present embodiment.

FIG. 2 is a diagram illustrating an example of a flowchart of a control process in a display control method to be executed by a plurality of control devices.

FIG. 3 is a diagram illustrating an example of a sequence chart of the display control method to be executed by the display control system in the present embodiment.

FIG. 4 is a diagram illustrating an example of a sequence chart of the display control method to be executed by the display control system in the present embodiment.

### MODE(S) FOR CARRYING OUT THE INVENTION

Hereinafter, an embodiment of the present invention will be described with reference to the drawings.

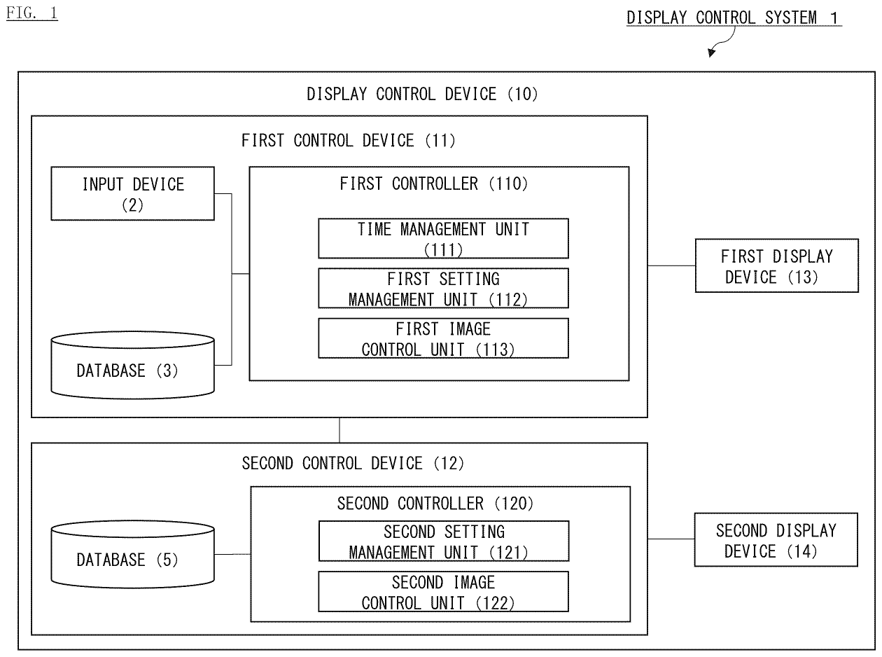

With reference to FIG. 1, a display control system according to the present invention will be described. The display control system is a system that controls the display of image information to a user. FIG. 1 is a block diagram illustrating a configuration of the display control system according to the present embodiment. A display control system 1 includes a first control device 11, a second control device 12, a first display device 13, and a second display device 14. These devices are mounted in a vehicle and provided in, for example, a display control device 10 mounted in the vehicle. These devices are connected together through, for example, CAN communication, Ethernet (registered trademark) communication, or another type of in-vehicle LAN to be capable of transmitting and receiving information to and from one another. The first control device 11 controls image display on the first display device 13. The second control device 12 controls image display on the second display device 14 on the basis of an instruction received from the first control device 11. The first display device 13 and the second display device 14 each display an image to the user. The user is an occupant of the vehicle, typically a driver of the vehicle. The user may be a passenger other than the driver. In the present embodiment, an example of controlling the display devices mounted in the vehicle will be described. The display devices to be subjected to the display control are not limited particularly to these display devices and may be any display devices that display the image information to a user. The first control device 11, the second control device 12, the first display device 13, and the second display device 14 are not limited to devices provided in the display control device 10. For example, the display devices may be portable terminal devices such as personal computers or smartphones. The display control system may include a plurality of second control devices 12.

The first control device 11 controls the first display device 13 so as to cause the first display device 13 to display an image. The first control device 11 includes an input device 2, a database 3, and a first controller 110. The first control device 11 and the second control device 12 are capable of exchanging information with each other.

As the input device 2, for example, a touch panel or a joystick that is disposed on a display and enables the user to perform a manual input operation, a microphone and a voice recognition device that enable the user to make a voice input, or the like can be used. Examples of the input device 2 include a display. In the case where a touch-panel display is used as the input device 2, the touch-panel display can serve as both the first display device 13 and the second display device 14. In the present embodiment, the input device 2 receives a selection input made by the user for making a selection from among display modes of the display devices. The display modes indicate how images are displayed on the display devices. The display modes include a display mode in which images are displayed in accordance with time points. Hereinafter, this display mode will also be referred to as a first display mode. The display modes include a display mode different from the first display mode. Hereinafter, this display mode will also be referred to as a second display mode. The second display mode is a display mode in which the display of the same image is continued irrespective of time points. For example, the second display mode is a display mode in which one image is displayed from switching to this display mode until switching to another display mode. There may be a plurality of second display modes.

The database 3 is a storage medium that stores information. The database 3 stores images to be displayed on the first display device 13. The images may include, for example, background images that serve as the background of a screen. The images include images for the first display mode and images for the second display mode. Each of the images for the first display mode is stored in association with time-point information and identification information (an image number) for identifying the image. The time-point information indicates a time point at which the image associated with the time-point information is displayed. As the image numbers, for example, in the case where there are 16 images for the first display mode, the images are assigned the image numbers of 1 to 16. As one or more images for one or more second display modes, one image is stored in association with each display mode.

The database 3 stores an image representing information to be provided to the user other than information on meters. The information to be provided to the user other than the information on meters of the vehicle is, for example, information related to what is called In-Vehicle Infotainment (IVI), which includes navigation information and/or entertainment information. For example, in the present embodiment, in the case where the first control device 11 causes the first display device 13 to display an image representing the information related to the infotainment, the first control device 11 may cause the first display device 13 to display the image representing the information related to the infotainment in front of a background image serving as the background of the screen.

The first controller 110 includes a computer with hardware and software. The computer includes a ROM that stores a program, a CPU that executes the program stored in the ROM, and a RAM that functions as an accessible storage device. The first controller 110 includes, as functional blocks, a time management unit 111, a first setting management unit 112, and a first image control unit 113. Note that, in the present embodiment, the functions of the first controller 110 are sorted into the three functional blocks, of which the functions will be described. The functions of the first controller 110 need not necessarily be sorted into the three blocks and may be sorted into two or fewer functional blocks or four or more functional blocks.

The time management unit 111 obtains time-point information indicating a current time point. For example, the time management unit 111 uses a GPS receiver and obtains the time-point information included in a GPS signal. The time management unit 111 may also obtain the time-point information from a built-in clock. For example, the time management unit 111 obtains the time-point information from the built-in clock in the case of failing to receive the time-point information from the GPS signal. This can prevent an image inconsistent with the time point from being displayed to make the user feel a sense of incongruity in the case of failing to receive the GPS signal.

In the present embodiment, in the case where the user selects the first display mode, the time management unit 111 obtains time-point information on the point in time of the selection. The time management unit 111 also obtains the time-point information at given intervals while the first display mode is set as the display mode. The time management unit 111 may obtain the time-point information when an accessory power supply or ignition power supply of the vehicle is turned on. The time management unit 111 may also set the time zone of the current position of the vehicle on the basis of positional information on the vehicle. The time management unit 111 determines whether the obtained current time point is a predetermined time point. The predetermined time point is a preset time point. The predetermined time point may include predetermined time points that are set at regular time intervals. For example, the predetermined time points are set at one-hour intervals, such as 12:00, 13:00, and 14:00, The predetermined time point may also be a time point within a predetermined time slot. That is, the time management unit 111 determines whether the obtained current time point is within the predetermined time slot.

In accordance with a time point, the first setting management unit 112 transmits an instruction about the display of an image to the second control device 12. The instruction about the display of an image is information for specifying an image to be displayed. The image to be displayed is, for example, an image corresponding to the time point. In the present embodiment, the database 3 stores in advance images corresponding to time points. In the case where the time management unit 111 determines that the current time point is the predetermined time point, the first setting management unit 112 transmits information for specifying, as the image to be displayed, an image corresponding to the predetermined time point (the current time point) to the second control device 12.

For example, in the case where the time management unit 111 determines that the current time point is the predetermined time point, the first setting management unit 112 transmits identification information for identifying the image corresponding to the predetermined time point to the second control device 12. The identification information is a number assigned to the image. The first setting management unit 112 may also transmit time-point information indicating the predetermined time point to the second control device 12.

Here, an example of a display control method according to the present embodiment will be described. In the present example, the predetermined time point includes predetermined time points that are set at one-hour intervals in advance. For example, the predetermined time points are set at one-hour intervals, such as 12:00, 13:00, and 14:00. In this case, whenever the current time point reaches one of the predetermined time points, such as 12:00, 13:00, and 14:00, the first setting management unit 112 gives the second control device 12 a specification of an image corresponding to the predetermined time point as the image to be displayed. As described above, whenever the one of the predetermined time points arrives with the passage of time, the first setting management unit 112 transmits, to the second control device 12, an instruction about the display of an image such that a displayed image is changed.

The first setting management unit 112 may manage a setting of the display mode. The first setting management unit 112 obtains a selection input of a display mode made by the user from the input device 2 and sets the display mode on the basis of the obtained selection input. For example, when the user makes a selection input for selecting the first display mode, the first setting management unit 112 sets the display mode to the first display mode. When the display mode is newly set, the first setting management unit 112 transmits a switching instruction to switch the display mode to the set display mode to the second control device 12. In the present embodiment, in the case where the display mode is set to the first display mode, the first setting management unit 112 transmits a switching instruction to switch the display mode to the first display mode to the second control device 12.

In the present embodiment, in the case where the display mode is set to the first display mode, the first setting management unit 112 transmits the switching instruction to the second control device 12 after transmitting identification information on an image corresponding to the point in time of the setting or time-point information on the point in time of the setting to the second control device 12. The second control device 12 receiving the switching instruction can thus cause the second display device 14 to display the image corresponding to the time point on the basis of the identification information or time-point information that have been received beforehand. It is thus possible to prevent such an image mismatch that the first display device 13 and the second display device 14 display images corresponding to different time points.

The first image control unit 113 executes an image control process of controlling image display on the first display device 13. In the image control process, the first image control unit 113 controls the first display device 13 such that images are displayed in accordance with time points. For example, in the case where the time management unit 111 determines that the current time point is the predetermined time point, the first image control unit 113 obtains an image corresponding to the predetermined time point from the database 3 and causes the first display device 13 to display the obtained image corresponding to the predetermined time point. Specifically, the first image control unit 113 transmits a control instruction including the image corresponding to the predetermined time point to the first display device 13.

The first image control unit 113 starts the image control process on the first display device 13 when the accessory power supply or ignition power supply of the vehicle is turned on. In this case, the first image control unit 113 controls the first display device 13 such that the first display device 13 displays the image corresponding to the current time point at the point in time of turning on the power supply, which is obtained by the time management unit 111.

The first image control unit 113 may store an image displayed to the user at a previous activation and identification information on the user (a user ID) in association with each other. For example, at the timing when the first display device 13 switches from an active state to a stopped state, the first image control unit 113 stores an image being displayed to the user as the image displayed to the user at the previous activation. When the first display device 13 is thereafter activated again, the first image control unit 113 identifies a user on-board the vehicle and causes the first display device 13 to display the image that is displayed at the previous activation and associated with the identification information on the user. For example, in the present embodiment, the identification information on the user is stored being linked to a key number. On the basis of the key number received from a key of the user, the first image control unit 113 identifies the user linked to the key number.

The first image control unit 113 may store an image displayed to the user in a previous first display mode and identification information on the user in association with each other. For example, at the timing of switching from the first display mode to the second display mode, the first image control unit 113 stores an image being displayed to the user as the image displayed to the user in the previous first display mode. When the first display mode is thereafter set again, the first image control unit 113 identifies a user on-board the vehicle and causes the first display device 13 to display the image that is displayed to the user in the previous first display mode and associated with the identification information on the user.

In the image control process, the first image control unit 113 may execute a process of offsetting a delay in display on the second display device 14. The timing of image display on the second display device 14 may be delayed if the transmission of a CAN signal to the second control device 12 is delayed due to a processing load on the first control device 11. In the present embodiment, the first image control unit 113 adjusts the timing of image display on the first display device 13 such that an error in timing of image display between the first display device 13 and the second display device 14 becomes within 100 ms. For example, the first image control unit 113 controls the image display on the first display device 13 at a timing delayed by a predetermined time period compared to a usual timing of the image display. The predetermined time period is, for example, 10 ms to 20 ms. Even if the timing of image display on the second display device 14 is delayed, this can prevent the user from receiving an impression of being a poor appearance due to the difference in timing of image display between the first display device 13 and the second display device 14.

The first image control unit 113 may cause the first display device 13 to display the image displayed at the previous activation if the user cannot perform an operational input. In this case, a second image control unit 122 may cause the second display device 14 to display an image displayed at a previous activation. This can prevent the first display device 13 and the second display device 14 from displaying no images due to a failure to switch images.

The second control device 12 controls the second display device 14 to cause the second display device 14 to display an image. The second control device 12 includes a database 5 and a second controller 120.

The database 5 is a storage medium that stores information. The database 5 stores images to be displayed on the second display device 14. The stored images are the same in specific content as the images stored in the database 3. Examples of the images include background images. The images include images for the first display mode and images for the second display mode. For specific details of the images for the first display mode and the images for the second display mode, the description about the database 3 will be incorporated as appropriate. The database 5 also stores an image representing information on meters. For example, in the present embodiment, in the case where the second control device 12 causes the second display device 14 to display an image representing the information on meters, the second control device 12 may cause the second display device 14 to display the image representing the information on meters in front of a background image that serves as the background of a screen.

The second controller 120 includes a computer with hardware and software. The computer includes a ROM that stores a program, a CPU that executes the program stored in the ROM, and a RAM that functions as an accessible storage device. In the case where the second controller 120 receives an instruction about the display of an image from the first control device 11, the second controller 120 controls the second display device 14 on the basis of the instruction such that the second display device 14 displays the image. The second controller 120 includes, as functional blocks, a second setting management unit 121 and the second image control unit 122. Note that, in the present embodiment, the functions of the second controller 120 are sorted into the two functional blocks, of which the functions will be described. The functions of the second controller 120 need not necessarily be sorted into the two blocks and may be sorted into one functional block or three or more functional blocks. Examples of the functions of the second controller will be described below.

In the case where the second setting management unit 121 receives identification information for identifying an image to be displayed on the second display device 14 from the first control device 11, the second setting management unit 121 saves the identification information. The image to be displayed is, for example, an image corresponding to the predetermined time point. In the case where the second setting management unit 121 receives identification information for identifying the image corresponding to the predetermined time point from the first control device 11, the second setting management unit 121 saves the identification information. In the case where the second setting management unit 121 receives time-point information indicating the predetermined time point from the first control device 11, the second setting management unit 121 saves identification information for identifying the image corresponding to the predetermined time point on the basis of the time-point information. In the present embodiment, the database 5 stores identification information on images corresponding to time points. On the basis of the obtained time-point information, the second setting management unit 121 obtains the identification information on the image corresponding to the predetermined time point from the database 5 and saves the obtained identification information. In the present embodiment, when the current time point is the predetermined time point, time-point information indicating the current time point is transmitted from the first control device 11, and identification information for identifying an image corresponding to the current time point is saved.

In the case where the second setting management unit 121 receives a switching instruction from the first control device 11, the second setting management unit 121 may set a display mode of the second display device 14. For example, in the case where the second setting management unit 121 receives a switching instruction to switch to the first display mode, the second setting management unit 121 switches the display mode to the first display mode.

The second image control unit 122 executes an image control process of controlling the image display on the second display device 14. In the image control process, in the case where the second image control unit 122 receives an instruction about the display of an image from the first control device 11, the second image control unit 122 controls the second display device 14 on the basis of the instruction such that the second display device 14 displays the image. For example, the second image control unit 122 obtains the image specified in the instruction about the display of the image from the database 5 and transmits a control instruction to display the obtained image to the second display device 14.

In the case where the identification information on the image corresponding to the predetermined time point has been saved by the second setting management unit 121, the second image control unit 122 obtains the image corresponding to the predetermined time point from the database 5 on the basis of the saved identification information and transmits a control instruction including the image corresponding to the predetermined time point to the second display device 14.

In the case where the second image control unit 122 receives a switching instruction to switch to the first display mode from the first control device 11, the second image control unit 122 may control the second display device 14 such that the second display device 14 displays the image corresponding to the predetermined time point. For example, in the case where the second setting management unit 121 switches the display mode to the first display mode, the second image control unit 122 controls the second display device 14 on the basis of the identification information saved at the point in time of the switching such that the second display device 14 displays the image corresponding to the predetermined time point. Note that the timing of obtaining the image corresponding to the predetermined time point from the database 5 on the basis of the saved identification information may be either before or after the switching to the first display mode.

As seen from the above, in the present embodiment, the first control device 11 first transmits the identification information for identifying the image corresponding to the predetermined time point to the second control device 12 and then transmits the switching instruction to switch to the first display mode to the second control device 12. As a result, the saved identification information is updated in the second control device 12 before the switching instruction is received. Then, at the timing of switching to the first display mode, the second control device 12 controls the image display on the second display device 14 on the basis of the identification information saved at the point in time of the switching. The second control device 12 can cause the second display device 14 to display the image corresponding to the predetermined time point on the basis of the updated identification information rather than previously saved identification information. It is thus possible to prevent such an image mismatch that the first display device 13 and the second display device 14 display images corresponding to different time points.

In the case where the second image control unit 122 receives no instruction about the display of an image from the first control device Il after the second display device 14 has been activated, the second image control unit 122 may control the second display device 14 such that the second display device 14 displays an image that is displayed on the second display device 14 at the previous activation. Examples of the case where the second image control unit 122 receives no instruction about the display of an image from the first control device 11 include the case where the communication with the first control device 11 is interrupted, the case where the second control device 12 receives an anomalous value rather than the identification information on the image, and the case where the first control device 11 is in the stopped state while the second control device 12 is in the active state. In the present embodiment, it is possible in such a case to prevent the second control device 12 from failing to determine an image to be displayed on the second display device 14 to cause the second display device 14 to display nothing. For example, at the timing when the second display device 14 switches from the active state to the stopped state, the second image control unit 122 stores an image being displayed to the user as the image displayed to the user at the previous activation. When the second display device 14 is thereafter activated again, the second image control unit 122 causes the second display device 14 to display the stored image displayed at the previous activation.

The second image control unit 122 may store an image displayed to the user in the previous first display mode. For example, at the timing of switching from the first display mode to the second display mode, the second image control unit 122 stores an image being displayed to the user as the image displayed to the user in the previous first display mode. When the first display mode is thereafter set again, the second image control unit 122 causes the second display device 14 to display the stored image that is displayed to the user in the previous first display mode.

In the case where images stored in the database 5 disappear or the case where the second image control unit 122 fails to read an image from the database 5, the second image control unit 122 may control the second display device 14 such that the second display device 14 displays the image that is displayed on the second display device 14 at the previous activation. This can prevent the second display device 14 from displaying nothing due to failing to obtain a predetermined image based on an instruction from the first control device 11.

The second image control unit 122 may store an image displayed to the user at the previous activation and identification information on the user (the user ID) in association with each other. When the second display device 14 is activated, the second image control unit 122 identifies a user on-board the vehicle and causes the second display device 14 to display the image that is displayed at the previous activation and associated with the identification information on the user.

The first display device 13 and the second display device 14 are displays that are installed extending from a driver's seat side to a front passenger seat side in the vehicle. These display devices each include, for example, a liquid crystal display or an organic EL display. The displays of these display devices each include a display region. In the case where these display devices each include a plurality of displays, the plurality of displays are arranged substantially linearly such that the displays adjoin each other. These display devices may include a speaker that outputs sound information. These display devices start the image display when the accessory power supply or ignition power supply of the vehicle is turned on.

The first display device 13 and the second display device 14 display images under the control by the first control device 11 and the second control device 12, respectively. Specifically, receiving a control instruction to control the display of an image from the first control device 11 and the second control device 12, the first display device 13 and the second display device 14 each display the image on the basis of the received control instruction, respectively. In the present embodiment, the first control device 11 transmits the control instruction to the first display device 13 such that the first display device 13 displays the image corresponding to the predetermined time point. Receiving the instruction from the first control device 11, the second control device 12 transmits a control instruction to the second display device 14 such that the second display device 14 displays the image corresponding to the predetermined time point. The first display device 13 and the second display device 14 thus display the images corresponding to the same predetermined time point. The displayed images include, for example, the background images. Hereinafter, an image control method according to the present embodiment will be described with, but not limited to in the present embodiment, an example in which the first display device 13 and the second display device 14 display images including the background images.

In the example, the display screen of the first display device 13 is constituted by the image representing information to be provided to the user, other than the information on meters, and the background image. The first display device 13 displays a display image that is the composition of the background image serving as the background of the display screen and the image displayed in front of the background image and representing the information to be provided to the user, other than the information on meters. The information to be provided to the user other than the information on meters of the vehicle is, for example, information related to what is called In-Vehicle Infotainment (IVI), which includes navigation information and/or entertainment information. The navigation information is information indicating guidance on a route of the vehicle. The navigation information includes, for example, map information, the current position of the vehicle, information on a route from the current position to a destination, and guidance information for the vehicle to travel along the route. The entertainment information is information including entertainment content such as music and videos. Examples of the entertainment information include an image illustrating a playback screen of a piece of music and a video such as a movie.

The first control device 11 obtains, using the first image control unit 113, the image representing the information to be provided to the user, other than the information on meters, and the background image from the database 3 and generates the display image that is the composition of the obtained images. The first control device 11 then transmits, using the first image control unit 113, a control instruction to the first display device 13 such that the first display device 13 displays the generated display image. The first display device 13 displays the display image on the basis of the control instruction. In this example, the database 3 stores background images corresponding to time points. When the current time point is the predetermined time point, the first control device 11 obtains a background image corresponding to the predetermined time point from the database 3 and controls the first display device 13 such that the first display device 13 displays a display image that is the composition of the obtained background image and the image representing the information to be provided to the user, other than the information on meters.

The display screen of the second display device 14 is constituted by an image representing the information on meters of the vehicle and the background image. The second display device 14 displays a display screen that is the composition of the background image serving as the background of the display screen and the image displayed in front of the background image and representing the information on meters. The information on meters includes, for example, speed information on the vehicle and energy information on the vehicle. The information on meters on the vehicle includes, for example, an image illustrating meters of the vehicle.

The second control device 12 obtains, using the second image control unit 122, the image representing the information on meters and the background image from the database 5 and generates the display image that is the composition of the obtained images. The second control device 12 then transmits, using the second image control unit 122, a control instruction to the second display device 14 such that the second display device 14 displays the generated display image. The second display device 14 displays the display image on the basis of the control instruction. In this example, the database 5 stores background images corresponding to time points. When the current time point is the predetermined time point, the second control device 12 obtains a background image corresponding to the predetermined time point from the database 5 and controls the second display device 14 such that the second display device 14 displays a display image that is the composition of the obtained background image and the image representing the information on meters. In the present embodiment, the first display device 13 and the second display device 14 are described as display devices configured to display the information related to the infotainment and the information on meters of the vehicle. The first display device 13 and the second display device 14 are not limited to the display devices and may be any devices that display different types of information.

The background images may be sorted into a plurality of types (themes) in accordance with how the background images are displayed. For example, the background images include background images for the first display mode. In the first display mode, a displayed background image changes in accordance with time points. The first display mode will also be referred to as Interactive background. The background images for the first display mode to be displayed at the time points are associated with numbers. Examples of the background images for Interactive background include images with the illustration of the sun that differ in the position of the sun in accordance with time points. For example, in the case where the predetermined time point is 18:00, a background image corresponding to the predetermined time point is an image with the illustration of the sun touching the horizon.

In the case where the user selects the first display mode (Interactive background), the first control device 11 generates, in accordance with the time point at the point in time of the selection, a display image including a background image corresponding to the time point and controls the first display device 13 such that the first display device 13 displays the display image. The first control device 11 also transmits, in accordance with the time point at the point in time of the selection, identification information on a background image corresponding to the time point to the second control device 12 and then transmits a switching instruction to switch the display mode to the first display mode to the second control device 12. The identification information is, for example, a signal value (will also be referred to as Dynamic Background State) indicating the number of the background image. The switching instruction will also be referred to as Cluster Skin Request. The switching instruction includes a signal value indicating the first display mode (Interactive background). The second control device 12 receives pieces of information from the first control device 11, in the order of the identification information and the switching instruction. The second control device 12 first saves the identification information on the background image corresponding to the time point. The second control device 12 then sets, on the basis of the switching instruction, the display mode of the background image to the first display mode (Interactive background), generates a display image including the background image corresponding to the time point on the basis of the saved identification information, and controls the second display device 14 such that the second display device 14 displays the display image. After setting the display mode, the second control device 12 notifies the first control device 11 that the display mode has been set to the first display mode (Interactive background).

In the case where the display mode is set to the first display mode (Interactive background), the first control device 11 obtains time-point information indicating the current time point at given intervals and determines whether the current time point is the predetermined time point. When the current time point is the predetermined time point, the first control device 11 transmits a signal value (Dynamic Background State) indicating the number of a background image corresponding to the predetermined time point to the second control device 12. The first control device 11 also controls the first display device 13 such that the first display device 13 displays a display image including a background image corresponding to the predetermined time point. When the second control device 12 receives the signal value (Dynamic Background State) indicating the number of the background image corresponding to the predetermined time point, the second control device 12 saves the number of the background image corresponding to the predetermined time point and controls the second display device 14 such that the second display device 14 displays a display image including the background image with the saved number.

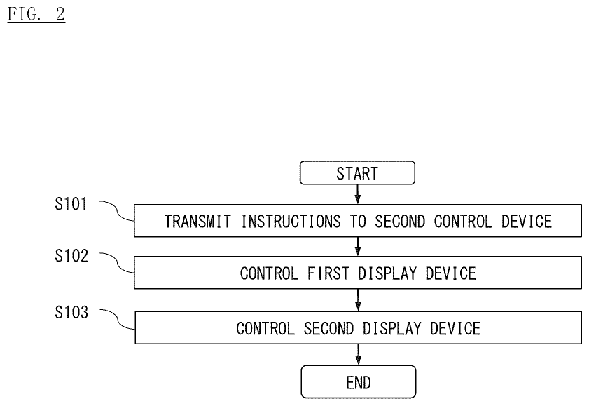

Next, with reference to FIG. 2, an example that shows a procedure of control for executing the display control method according to the present embodiment will be described. FIG. 2 is a diagram illustrating an example of a flowchart of a control process in the display control method to be executed by the display control device.

In step S101, the first control device Il transmits an instruction about the display of an image to the second control device 12 in accordance with a time point. For example, when the current time point is the predetermined time point, the first control device 11 transmits an instruction to display an image corresponding to the predetermined time point to the second control device 12. In step S102, the first control device 11 controls the first display device 13 such that the first display device 13 displays the image in accordance with the time point. For example, the first control device 11 transmits a control instruction to the first display device 13 such that the first display device 13 displays an image corresponding to the predetermined time point. On the basis of the control instruction from the first control device 11, the first display device 13 displays the image corresponding to the predetermined time point. In step S103, on the basis of the instruction about the display of the image received from the first control device 11, the second control device 12 controls the second display device 14 such that the second display device 14 displays the image. For example, the second control device 12 transmits a control instruction to the second display device 14 such that the second display device 14 displays the image corresponding to the predetermined time point. On the basis of the control instruction from the second control device 12, the second display device 14 displays the image corresponding to the predetermined time point. As seen from the above, in the present embodiment, the image display of the first display device 13 and the second display device 14 can be controlled with synchronized timings of displaying images by transmitting the instruction from the first control device 11 to the second control device 12 when the current time point reaches the predetermined time point.

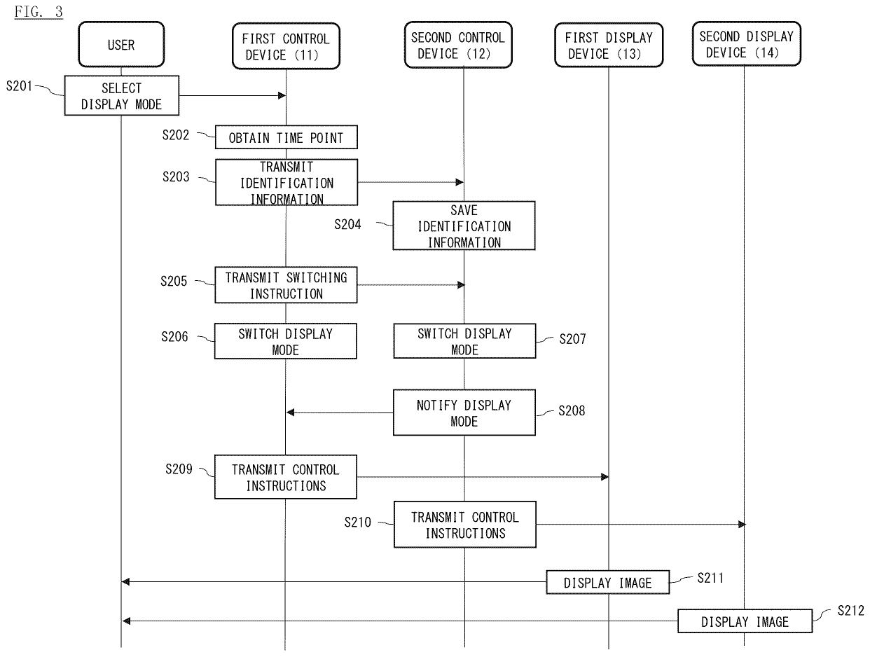

Next, with reference to FIG. 3, a processing procedure in the display control method to be executed by the display control system I will be described. FIG. 3 is a diagram illustrating an example of a sequence chart of the display control method to be executed by the display control system in the present embodiment. FIG. 3 illustrates an example of the processing procedure in the display control method executed when the user sets the display mode to the first display mode. Note that the steps illustrated in FIG. 3 constitute an example of the processing procedure for executing the display control method according to the present embodiment. The steps do not constitute an essential configuration and may be configured as appropriate when needed.

In step S201, the user selects the first display mode as the display mode with the input device 2 of the first control device 11. In step S202, in the case where the first display mode is selected, the first control device 11 obtains the current time point. In step S203, when the current time point is the predetermined time point, the first control device 11 transmits identification information for identifying an image corresponding to the predetermined time point to the second control device 12. In step S204, the second control device 12 saves the identification information. In step S205, the first control device 11 transmits a switching instruction to switch the display mode to the first display mode to the second control device 12. In step S206, the first control device 11 switches the display mode of the first display device 13 to the first display mode. In step S207, the second control device 12 switches the display mode of the second display device 14 to the first display mode.

In step S208, the second control device 12 notifies the first control device 11 of the display mode of the second display device 14. In step S209, the first control device 11 transmits a control instruction to display an image corresponding to the predetermined time point to the first display device 13. In step S210, the second control device 12 transmits a control instruction to display an image corresponding to the predetermined time point to the second display device 14. In step S211, the first display device 13 displays the image corresponding to the predetermined time point. In step S212, the second display device 14 displays the image corresponding to the predetermined time point. As seen from the above, in the case where the user sets the display mode to the first display mode, the first display device 13 and the second display device 14 display the images corresponding to the current time point of the point in time of the setting.

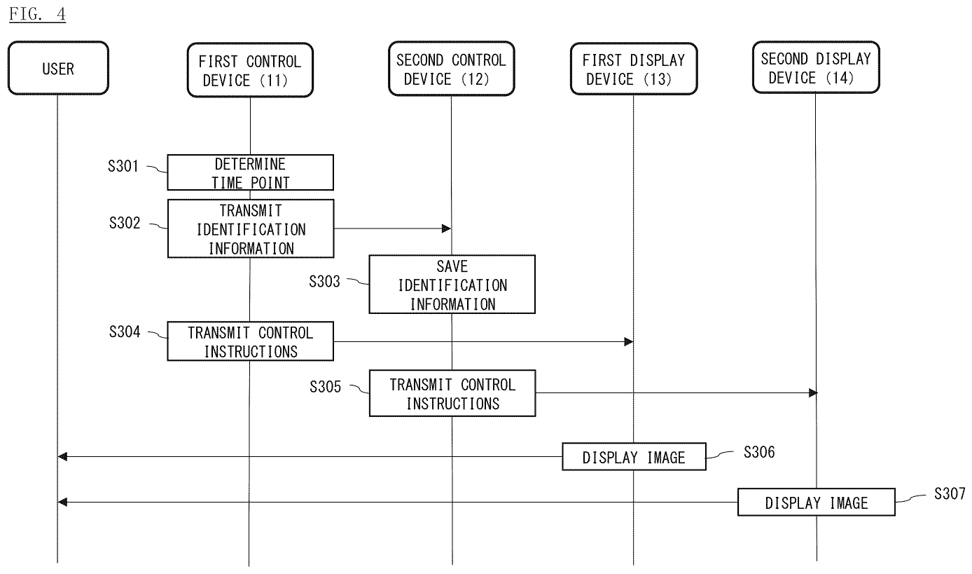

Next, with reference to FIG. 4, a processing procedure in the display control method to be executed by the display control system 1 will be described. FIG. 4 is a diagram illustrating an example of a sequence chart of the display control method to be executed by the display control system in the present embodiment. FIG. 4 illustrates an example of the processing procedure in the display control method executed while the first display mode is set as the display mode. While the first display mode is set as the display mode, the current time point is obtained at given intervals, and the steps illustrated in FIG. 4 are repeatedly executed. Note that the steps illustrated in FIG. 4 constitute an example of the processing procedure for executing the display control method according to the present embodiment. The steps do not constitute an essential configuration and may be configured as appropriate when needed.

In step S301, the first control device 11 determines a time point. For example, the first control device 11 obtains the current time point and determines whether the obtained current time point is the predetermined time point. In the case where the current time point is determined to be the predetermined time point, the first control device 11 transmits in step S302 identification information for identifying an image corresponding to the predetermined time point to the second control device 12. In step S303, the second control device 12 saves the identification information.

In step S304, the first control device 11 transmits a control instruction to display an image corresponding to the predetermined time point to the first display device 13. In step S305, the second control device 12 transmits a control instruction to display the image corresponding to the predetermined time point to the second display device 14. In step S306, the first display device 13 displays the image corresponding to the predetermined time point. In step S307, the second display device 14 displays the image corresponding to the predetermined time point. As seen from the above, in the present embodiment, in the case where the display mode is set to the first display mode, the determination of the current time point is executed at given intervals, and whenever the predetermined time point arrives, the images displayed on the first display device 13 and the second display device 14 are updated.

In the present embodiment, a plurality of control devices that control a plurality of respective display devices are included. An advantage of including the plurality of control devices is, for example, that the plurality of display devices can be controlled such that the display devices display different images. It is possible to cause any one of the display devices to display the information on meters of the vehicle and cause another of the display devices to display the information related to IVI. It is also possible to activate only one of the display devices first. For example, it is possible to activate the display device for the information on meters earlier than the display device for the information related to IVI. It is also possible to enhance the security of the entire display control system. It is also possible to increase the combinations of components constituting each control device.

As described above, in the display control method, the display control device, and the display control system according to the present embodiment, the first control device transmits an instruction about the display of an image to the second control device in accordance with a time point, controls the first display device such that the first display device displays an image in accordance with the time point, and when the second control device receives the instruction from the first control device, the second control device controls the second display device on the basis of the instruction such that the second display device displays the image. This makes it possible to control the image display of the plurality of display devices with the synchronized timings of displaying images in the case where a plurality of terminal devices control the respective display devices.

In the display control method, the display control device, and the display control system according to the present embodiment, the first control device, in the case where a user makes a selection input for making a selection of a display mode in which the image is displayed in accordance with the time point: obtains the time point; transmits, when the obtained time point is a predetermined time point, identification information for identifying the image corresponding to the predetermined time point to the second control device; transmits a switching instruction to switch to the display mode to the second control device; and controls the first display device such that the first display device displays the image corresponding to the predetermined time point, and the second control device saves, when the identification information from the first control device is received, the identification information, and controls, when the switching instruction from the first control device is received, the second display device on the basis of the saved identification information such that the second display device displays the image corresponding to the predetermined time point. This enables, at the timing of switching to the first display mode, the second display device to display an image corresponding to the same time point as the first display device rather than an image displayed at a previous time.

In the display control method, the display control device, and the display control system according to the present embodiment, the first control device, in the case where a user makes a selection input for making a selection of a display mode in which the image is displayed in accordance with the time point: obtains the time point; transmits, when the obtained time point is a predetermined time point, time-point information indicating the predetermined time point to the second control device; transmits a switching instruction to switch to the display mode to the second control device; and controls the first display device such that the first display device displays the image corresponding to the predetermined time point, and the second control device saves, when the time-point information from the first control device is received, identification information for identifying the image corresponding to the predetermined time point on the basis of the time-point information, and controls, when the switching instruction from the first control device is received, the second display device on the basis of the saved identification information such that the second display device displays the image corresponding to the predetermined time point. This enables, at the timing of switching to the first display mode, the second display device to display an image corresponding to the same time point as the first display device rather than an image displayed at a previous time.

In the display control method, the display control device, and the display control system according to the present embodiment, the second control device controls, when the instruction from the first control device has not been received after the second display device has been activated, the second display device such that the second display device displays the image that the second display device displays at a previous activation. This makes it possible to prevent the second display device from displaying nothing while no instruction is received from the first control device.

In the display control method, the display control device, and the display control system according to the present embodiment, the second control device controls, when communication with the first control device is interrupted after the second display device has been activated, the second display device such that the second display device displays the image that the second display device displays at the previous activation. This makes it possible to prevent the second display device from displaying nothing while the communication with the first control device is interrupted.

In the display control method, the display control device, and the display control system according to the present embodiment, each of the first control device and the second control device stores the image corresponding to each of time points for each of the time points. This eliminates the need for the transmission and reception of the images between the first control device and the second control device, thus enabling a reduction in communication load.

In the display control method, the display control device, and the display control system according to the present embodiment, the first control device and the second control device store the images that the first display device and the second display device display to a user at a previous activation and identification information on a previous user in association with each other, respectively. This makes it possible to change an image to be displayed for each user when the display devices are activated.

In the display control method, the display control device, and the display control system according to the present embodiment, the first control device is a device mounted in a vehicle, obtains the time point when an accessory power supply or ignition power supply of the vehicle is turned on, and controls the first display device such that the first display device displays the image corresponding to the obtained time point. This makes it possible to display an image corresponding to the time point of the point in time when the accessory power supply or ignition power supply of the vehicle is turned on.

The embodiment explained above is described to facilitate the understanding of the present invention and is not described to limit the present invention. It is therefore meant that the constituent elements disclosed in the above embodiment include all design changes and equivalents falling within the technical scope of the present invention.

### DESCRIPTION OF REFERENCE NUMERALS

1 display control system
   11 first control device
      110 first controller
         111 time management unit
         112 first setting management unit
         113 first image control unit
   12 second control device
      120 second controller
         121 second setting management unit
         122 second image control unit
   13 first display device
   14 second display device

1. A display control method to be executed by a first control device and a second control device, the first control device controlling a first display device, the second control device controlling a second display device, the display control method comprising:
in a case where a user makes a selection input for selecting a display mode in which an image is displayed in accordance with a time point,
obtaining the time point by the first control device;
transmitting, when the obtained time point is a predetermined time point, time-point information indicating the predetermined time point or identification information for identifying the image corresponding to the predetermined time point to the second control device by the first control device;
transmitting a switching instruction to switch to the display mode to the second control device by the first control device;
controlling the first display device such that the first display device displays the image corresponding to the predetermined time point by the first control device;
saving, when the time-point information or the identification information from the first control device is received, the identification information by the second control device; and
controlling, when the switching instruction from the first control device is received, the second display device on a basis of the saved identification information such that the second display device displays the image corresponding to the predetermined time point by the second control device.

2.-3. (canceled)

4. The display control method according to claim 1, wherein the second control device
controls, when the information for specifying the image corresponding to the predetermined time point from the first control device has not been received after the second display device has been activated, the second display device such that the second display device displays the image that the second display device displays at a previous activation.

5. The display control method according to claim 4, wherein the second control device controls, when communication with the first control device is interrupted after the second display device has been activated, the second display device such that the second display device displays the image that the second display device displays at the previous activation.

6. The display control method according to claim 1, wherein each of the first control device and the second control device stores the image corresponding to each of the time points for each of the time points.

7. The display control method according to claim 1, wherein the first control device and the second control device each store the image that the first display device and the second display device display to a user at a previous activation and identification information on the user in association with each other, respectively.

8. The display control method according to claim 1, wherein the first control device:
is a device mounted in a vehicle;
obtains the time point when an accessory power supply or ignition power supply of the vehicle is turned on; and
controls the first display device such that the first display device displays the image corresponding to the obtained time point.

9. A display control device comprising:
a first control device that controls a first display device; and
a second control device that controls a second display device, wherein
the first control device:
in a case where a user makes a selection input for selecting a display mode in which an image is displayed in accordance with a time point.
obtains the time point;
transmits, when the obtained time point is a predetermined time point, on a basis of the saved identification information for identifying the image corresponding to the predetermined time point to the second control device;
transmits a switching instruction to switch to the display mode to the second control device; and
controls the first display device such that the first display device displays the image corresponding to the predetermined time point, and
the second control device;
saves, when the time-point information or the identification information from the first control device is received, the identification information; and
controls, when the switching instruction from the first control device is received, the second display device on a basis of the saved identification information such that the second display device displays the image corresponding to the predetermined time point.

10. A display control system comprising;
a first control device that controls a first display device; and
a second control device that controls a second display device, wherein
the first control device:
in a case where a user makes a selection input for selecting a display mode in which an image is displayed in accordance with a time point.
obtains the time point;
transmits, when the obtained time point is a predetermined time point, time-point information indicating the predetermined time point or identification information for identifying the image corresponding to the predetermined time point to the second control device;
transmits a switching instruction to switch to the display mode to the second control device; and
controls the first display device such that the first display device displays the image corresponding to the predetermined time point, and
the second control device;
saves, when the time-point information or the identification information from the first control device is received, the identification information; and
controls, when the switching instruction from the first control device is received, the second display device on a basis of the saved identification information such that the second display device displays the image corresponding to the predetermined time point.
